(19) United States
(12) Patent Application Publication
(10) Pub. No.: US 2026/0301699 A1
(43) Pub. Date: Oct. 1, 2026

(54) TECHNIQUE FOR MAINTAINING COLOR ACCURACY AND REDUCE POWER CONSUMPTION FOR LCDS

(71) Applicant: ATI Technologies ULC, Markham (CA)

(72) Inventors: Troy Alexander Giorshev, Markham (CA); Shu Key Keith Lee, Markham (CA)

(73) Assignee: ATI Technologies ULC, Markham (CA)

(21) Appl. No.: 19/092,446

(22) Filed: Mar. 27, 2025

(51) Int. Cl. G09G 3/34; G02F 1/1335; G09G 3/36

(52) U.S. Cl. CPC G09G 3/3413; G02F 1/133614; G09G 3/3607; G09G 2320/0233; G09G 2320/0242; G09G 2340/06

(57) ABSTRACT

A quantum dot liquid crystal display has a backlight generated by a light emitting diode (“LED”) that is typically blue and a quantum dot film that performs color conversion to red and green to produce white light. While cheap and efficient, the LEDs in such displays illuminate the pixels unevenly, and the distribution of uneven illumination is different for different wavelengths of light (e.g., red, green, and blue). A technique to compensate for this aspect includes measuring certain optical characteristics of the uneven illumination distribution, processing such measurements, and applying the results of such processing to the “desired” input image to generate an output image for display.

### BACKGROUND

“Dual-panel” displays include a light producing element (e.g., a backlight) that generates light for pixels and a control element (e.g., liquid crystal element) that modulates the light, which together control the color of the pixels. The control elements in complex modern displays consider a number of factors to produce pleasing and accurate image output.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2 illustrates an example of a display system;

FIG. 3 illustrates a front view of a portion of the display device, according to an example;

FIG. 4 illustrates a blown-up cross-sectional view of the portion of the display device of FIG. 3;

FIGS. 5 and 6 illustrate example light spread functions for the backlight of the display device; and

FIG. 7 is a flow diagram of a method for controlling a display device, according to an example.

### DETAILED DESCRIPTION

A quantum dot liquid crystal display has a backlight generated by a plurality of light emitting diodes (“LED”) that are typically blue and a quantum dot film that performs color conversion to red and green to produce white light. While cheap and efficient, the LEDs in such displays illuminate the pixels unevenly, and the distribution of uneven illumination is different for different wavelengths of light (e.g., red, green, and blue).

A technique is provided herein to account for this effect. In brief, this technique involves using data that characterizes the backlight illumination from the various LEDs at each pixel to apply adjustments to the input color in order to achieve the desired color. In particular, a calibration technique measures the contribution of each backlight LED to each pixel in a tristimulus (“XYZ”) color space (e.g., at manufacture or test time). For any given pixel, multiplying this contribution by the backlight LED power gives a power-scaled version of that contribution. Summing the power-scaled version of the contribution from each LED for a given pixel gives the total contribution of the overall LED backlight to the pixel. By expressing this as a matrix, taking the inverse of this matrix, and multiplying that inverse by the input color, an output is produced which expresses how to activate the color filter elements for the pixel in order to generate the desired color as actually reflected in the input image.

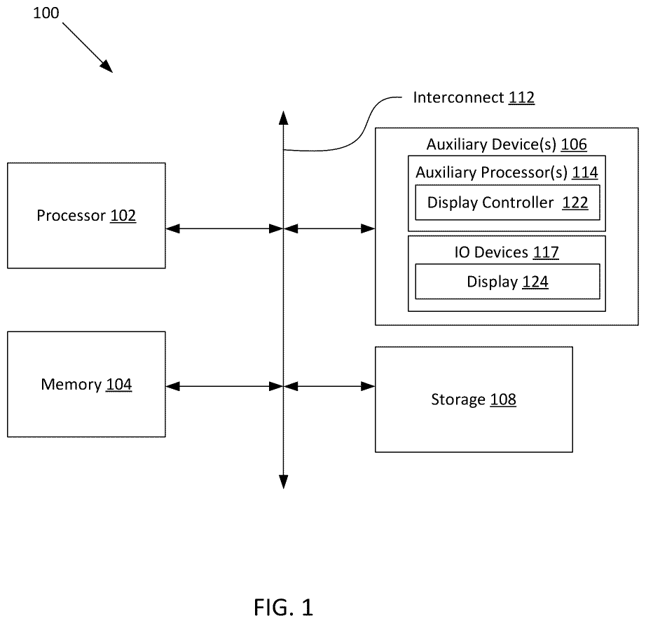

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes a display controller 122. The display controller 122 accepts pixel data for an image to be displayed on the display 124 and outputs the image to that display. In particular, as described elsewhere herein, the display controller 122 compensates for backlight-induced distortion. The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device 124, a speaker, a printer, a haptic feedback device, one or more lights, an antenna, or a network connection (e.g., a wireless local area network card for transmission and/or reception of wireless IEEE 802 signals).

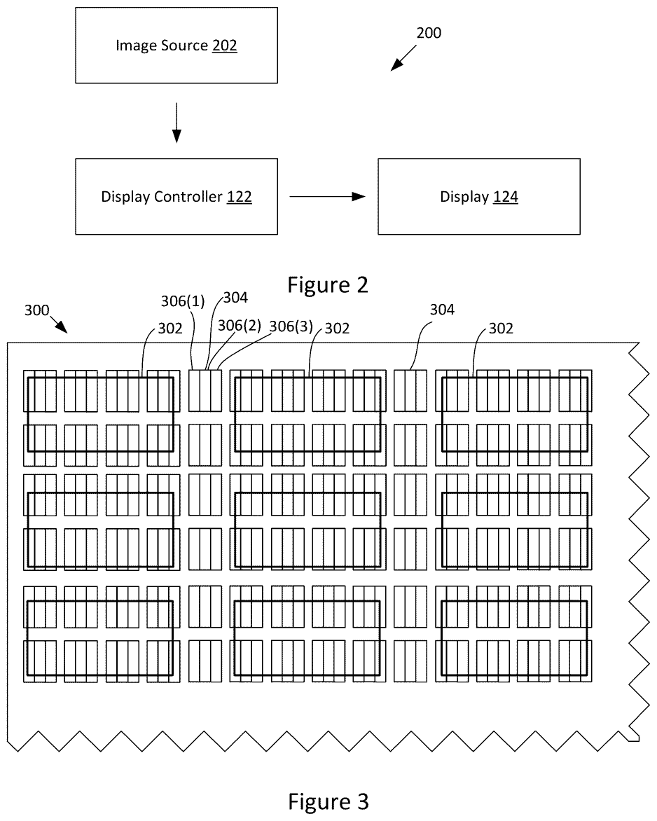

FIG. 2 illustrates an example of a display system 200. The display system 200 includes an image source 202, the display controller 122, and the display 124. The image source 202 generates an image for display on the display 124. This image can be generated from any source. In various examples, software such as an operating system, application, or other software, produces image content for a frame buffer. In some examples, an operating system or other entity composites image data from multiple sources (e.g., a windowing system, an application, or other sources) to generate a frame for output. In these various examples, the image source 202 is the entity or entities that generates the image to be output to the display 124. The display controller 122 reads the image generated by the image source 202 and provides that image to the display 124. In some examples, the display 124 has certain characteristics that require adjustments to the raw data provided by the image source 202. Thus, in such examples, the display controller 122 performs adjustments to the data from the image source 202 and outputs adjusted image data to the display 124 for presentation. In particular, the display device 124 is a mini-LED (“light emitting diode”) quantum-dot light-emitting-diode display that has certain characteristics that distort image data, requiring adjustment.

FIG. 3 illustrates a front view of a portion 300 of the display device 124, according to an example. The display device 124 includes a plurality of mini-LEDs 302, which, in conjunction with a quantum dot layer not depicted in FIG. 3, act as backlights. The display device 124 also includes liquid crystal pixels 304 that control colors for each pixel by controlling how much light from the mini-LED backlights 302 passes through. Although only a small number of mini-LED backlights 302 and liquid crystal pixels 304 are labeled in FIG. 3, it should be understood that there are many such elements in the display arranged in a regular grid pattern as shown, and that elements with similar shapes in FIG. 3 are the same type of element.

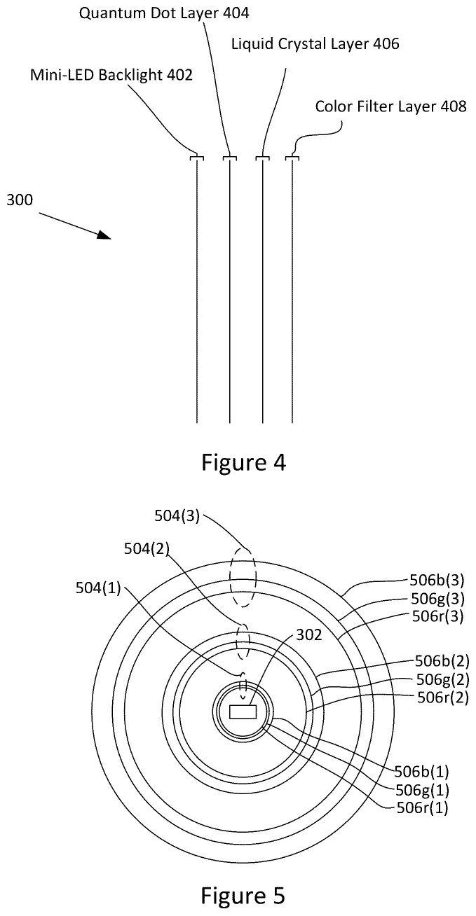

FIG. 4 illustrates a blown-up cross-sectional view of the portion 300 of the display device 124 of FIG. 3. Although certain layers are illustrated in FIG. 4, it should be understood that other layers may be present as well.

The portion 300 of the display device 124 includes a mini-LED backlight layer 402, a quantum dot layer 404, a liquid crystal layer 406, and a color filter layer 408. The mini-LED backlight layer 402 includes the plurality of mini-LEDs 302 shown in FIG. 3. The quantum dot layer 404 is a film including quantum dots, which are semiconductor nanocrystals that can produce monochromatic color (e.g., as a combination of reg, green, and blue) when excited with the light emitted from the mini-LEDs 302. In an example, the mini-LEDs 302 are blue LEDs (rather than white, where white LEDs may be used in a display that does not use a quantum dot film), and the quantum dots perform color conversion, generating a source for red and green light that, along with the blue light, produce white light. The quantum dot layer is a lower cost solution than a solution that uses one or more true white LED backlights. Thus the mini-LED backlight 402 and quantum dot layer 404 operating together provide a white backlight.

The liquid crystal layer 406 includes a plurality of liquid crystal elements, in some examples, one per color sub-pixel. Applying a voltage to a liquid crystal element modifies the amount of light passed through that liquid crystal element. Together with the color filter layer 408, this allows the display device 124 to control the color of each pixel.

Referring now to FIGS. 3 and 4 together, more particularly, each liquid crystal pixel 304 has a corresponding color sub-pixel element 306. One illustrated liquid crystal pixel 304 has three such labeled sub-pixel element 306. Each sub-pixel element 306 is a combination of a color filter that filters a particular color of light (such as red, green, or blue—R, G, or B) emitted from the mini-LED backlight 302, and a liquid crystal element that controls the amount of light output from a corresponding filter. Each pixel in the image data provided by the image source 202 has a value for the three color components red, green, and blue. For each such pixel, the display controller 122 controls a corresponding liquid crystal pixel 304 by controlling the liquid crystal element to pass an amount of light dictated by the corresponding color component. For example, for a pixel having a red value of 1.0 (on a scale between 0.0 and 1.0), a green value of 0.2, and a blue value of 0.2, the display 124 causes a first liquid crystal element to fully pass light from the corresponding red filter, a second liquid crystal element to pass 20% of light corresponding to a green filter, and a third liquid crystal element to pass 20% of light corresponding to a blue filter.

An ideal backlight would produce the exact same color at each pixel for the same value applied to the liquid crystals for those pixels. In other words, an ideal backlight would have a perfectly even intensity and color distribution. However, the nature of the illustrated quantum dot mini-LED backlight means that there are variations in the intensity distribution. In addition, the presence of the quantum dot layer 404 means that the variations differ by color. For example, the intensity spread for red is different than that for blue, which is also different than that for green.

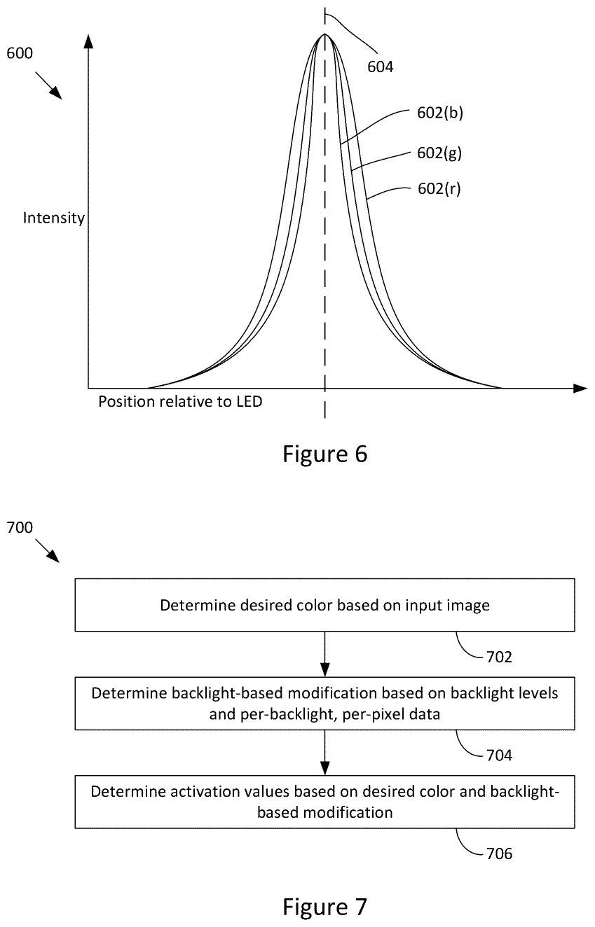

FIGS. 5 and 6 illustrate example light spread functions for the backlight of the display device 124. In FIG. 5, a single mini-LED 302 is illustrated, and the gradient of intensity from that mini-LED 302, in each of three color channels is shown with several sets of concentric rings. In particular, the mini-LED 302 emits a maximum amount of light in the direct vicinity of that mini-LED (e.g., in the center of all of the rings). With distance from the mini-LED 302, the intensity of that light decreases. Thus, a gradient of light intensity exists, with the highest intensity at the center, and that intensity dropping off with greater distance from the mini-LED 302.

In FIG. 5, the gradient is illustrated with sets 504 of concentric rings 506. Each set 504 of rings 506 illustrates a threshold light intensity reduction. The closest set 504(1) to the mini-LED 302 represents a first threshold (e.g., 80%), where light intensity within that ring is above 80% of the maximum light intensity (which exists, for example, at the location of the mini-LED 302), the next farthest set 504(2) represents a second threshold (e.g., 50%), and the farthest set 504(3) represents a third threshold (e.g., 20%).

In addition, within each set 504, three different color channel rings 506 are included. Each color channel ring 506 represents the threshold for a corresponding set for a particular color. For example, for set 504(1), color channel ring 506r(1) indicates the first threshold for the color red, color channel ring 506g(1) indicates the first threshold for the color green, and color channel ring 506b(1) indicates the first threshold for the color blue. In general, a reference number of the format 306c(x) means a color channel ring for color c (i.e., either red, green, or blue), in ring number x, and indicates the position of threshold number x for color c.

FIG. 6 is a graph 600 illustrating alight spread function 601 for each color, according to an example. In particular, the graph 600 includes multiple light spread function plots 602, each associated with a different color (602(r) for red, 602(g) for green, and 602(b) for blue). Each plot illustrates position relative to the mini-LED 302 on the x-axis, (with the LED being located at the center line 604), and intensity on the y-axis. As can be seen, the intensity falls off with distance from the LED. Further, the degree to which this falloff occurs is different for each color.

It should be noted that the graph 600 of FIG. 6 illustrates contribution to one pixel from a single mini-LED 302. However, as the display 124 includes many mini-LEDs 302, the backlight intensity at any given pixel depends on the contribution for multiple mini-LEDs 302. Moreover, each particular mini-LED 302 can have a power state indicating the degree to which that mini-LED 302 is powered and thus the intensity of the light emitted from any given mini-LED 302 is dependent on its power. Consequently, the backlight amount at any given pixel location is dependent on the position with respect to multiple mini-LEDs 302 as well as the power amount of each such mini-LED 302.

As stated above, a given input image for display on the display device 124 indicates particular color intensity values for each of three color channels. However, properly displaying those color intensity values at any given pixel 304 of the display 124 is accomplished by modifying the values in the input image by correcting for the intensity variations in each of three color values produced by each of a plurality of mini-LED backlights 302. In other words, to correctly display colors on the display 124 as “intended” by the image content of the input image, the color intensity values provided by that input image should be adjusted to counteract the variations in intensity from multiple mini-LEDs 302, which are different in each different color channel. Thus, techniques are provided herein for performing such adjustments.

In general, pixel colors in image content, such as that received from image source 202, are represented in an RGB color space. A different color space—the tristimulus XYZ (CIE (“International Commission on Illumination”) 1931 XYZ) color space—is more useful. This is a color space in which Y represents luminance (e.g., the perceived brightness) and X and Z together represent chromaticity (e.g. the perceived color, independent of its brightness). Representing colors in the tristimulus XYZ color space allows for computationally simple color mixing. When two initial colors are combined, the resulting color's XYZ tristimulus values are determined by component-wise summation of the initial colors' respective X, Y, and Z tristimulus values. Converting the image content to this color space allows for a representation of the desired activation of the LCD color elements 306 as a function of the contribution from the mini-LED backlights 302 and the image content represented in the tristimulus color space. In particular, the following mathematical formula applies for a pixel having coordinates r (vertical), and c (horizontal) (e.g., “row” and “column”):

$$[ \begin{matrix}{X}_{r , c O} \\ {y}_{r , c O} \\ {Z}_{r , c O}\end{matrix} ] = [ \begin{matrix}{X}_{r , c R} & {X}_{r , c G} & {X}_{r , c B} \\ {Y}_{r , c R} & {Y}_{r , c G} & {Y}_{r , c B} \\ {Z}_{r , c R} & {Z}_{r , c G} & {Z}_{r , c B}\end{matrix} ] [ \begin{matrix}{r}_{r , c} \\ {g}_{r , c} \\ {b}_{r , c}\end{matrix} ]$$

In this equation, X_{r,c O}, Y_{r,c O}, and Z_{r,c O} are the desired XYZ tristimulus output values (the “output matrix”). r_{r,c}, g_{r,c}, and b_{r,c} are the activation values of the LCD color elements 306 of the pixel at r, c, for red, green, blue colors respectively (the “activation matrix”). The backlight contribution matrix

$$[ \begin{matrix}{X}_{r , c R} & {X}_{r , c G} & {X}_{r , c B} \\ {Y}_{r , c R} & {Y}_{r , c G} & {Y}_{r , c B} \\ {Z}_{r , c R} & {Z}_{r , c G} & {Z}_{r , c B}\end{matrix} ]$$

represents the light emitted from the mini-LED backlights 302 (that is, all backlights, to the extent that they affect the pixel at r, c, and affected by the power levels of each backlight). More specifically, X_{r,c R}, Y_{r,c R}, and Z_{r,c R} represent the tristimulus color components for red, X_{r,c G}, Y_{r,c G}, and Z_{r,c G} represent the tristimulus color components for green, and X_{r,c B}, Y_{r,c B}, and Z_{r,c B} represent the tristimulus color components for blue. Put differently, the tristimulus color components for red represent the total light emitted from the pixel at r, c if the red liquid crystal color element 306 were fully transmissive and the blue and green liquid crystal color elements 306 were fully closed. The tristimulus color components for green and blue are similar values for the green liquid crystal color element 306 and for the blue liquid crystal color element 306, respectively.

It should be understood that X, Y, and Z are color components in the tristimulus color space and that each of these components has some measurable value when the red liquid crystal color element 306 is fully open and green and blue are fully closed, and will have different values when green is fully open and red and blue are fully closed, as well as when blue is fully open and red and green are fully closed.

It should also be understood that the backlight contribution matrix is the contribution to the pixel (r, c) from all mini-LED backlights 302, given the power level to each of those mini-LED backlights 302. In other words, the formula above expresses the output color for pixel r, c in the XYZ color space as a function of the activation values of the liquid crystal color elements 306 of that pixel and of the power setting for each mini-LED backlight 302. Because it is desirable to know what the activation values of the liquid crystal color elements 306, so that it can be determined how to set those values, a second expression that solves for the activation matrix is as follows:

$$[ \begin{matrix}{r}_{r , c} \\ {g}_{r , c} \\ {b}_{r , c}\end{matrix} ] = {[ \begin{matrix}{X}_{r , c R} & {X}_{r , c G} & {X}_{r , c B} \\ {Y}_{r , c R} & {Y}_{r , c G} & {Y}_{r , c B} \\ {Z}_{r , c R} & {Z}_{r , c G} & {Z}_{r , c B}\end{matrix} ]}^{- 1} [ \begin{matrix}{r}_{r , c D} \\ {g}_{r , c D} \\ {b}_{r , c D}\end{matrix} ]$$

This expression is referred to as the “activation matrix expression” herein. Here, the subscript “O” for “output” has been replaced with a “D” for “desired,”—this matrix—the “desired output matrix”—represents the color that is desired to be output from pixel r, c. This color is specified by the input image from the image source 202, converted to the XYZ color space. Here, the backlight contribution matrix has a “−1” superscript, indicating the inverse of the backlight contribution. Thus, the inverse of the backlight contribution matrix multiplied with the desired output matrix produces the activation matrix, determining the settings for the liquid crystal color elements 306 of the pixel. Because the desired output matrix is known—it is specified by the input image converted into the XYZ color space, the inverse of the backlight contribution matrix must be determined. In shorthand, the backlight contribution matrix is sometimes referred to as “M” herein. In addition, M can be different for each different pixel and thus M_{r,c}—a matrix specific to each pixel—is sometimes used.

As stated above, the backlight contribution matrix represents the light contribution from all mini-LEDs 302 to pixel r,c. Thus, this matrix includes contributions from all mini-LEDs 302 to that pixel. The matrix M can thus be expanded out to (and is thus equal to) the “total backlight contribution expression”:

$${b}^{( 1 )} L S {F}_{r , c}^{( 1 )} + {b}^{( 2 )} L S {F}_{r , c}^{( 2 )} + {b}^{( 3 )} L S {F}_{r , c}^{( 3 )} … .$$

Here, b^{(N)} is the power level or illumination level of the Nth mini-LED 302 and

$$LS {F}_{r , c}^{( N )} .$$

is the light spread function for the Nth mini-LED 302 at pixel r,c. For purposes of normalization, in some examples, this entire series is divided by PW_{DISP}, which is the brightest level among all pixels of the display 124 when all mini-LEDs 302 are fully powered and all liquid crystal color elements 306 are fully open for all pixels. The light spread function for backlight N at pixel r, c represents the contribution of backlight N to the XYZ color components at pixel r, c when backlight N is fully powered. The light spread function can be expressed as:

$$LS {F}_{r , c}^{( B )} = [ \begin{matrix}{X}_{r , c R}^{( B )} & {X}_{r , c G}^{( B )} & {X}_{r , c B}^{( B )} \\ {Y}_{r , c R}^{( B )} & {Y}_{r , c G}^{( B )} & {Y}_{r , c B}^{( B )} \\ {Z}_{r , c R}^{( B )} & {Z}_{r , c G}^{( B )} & {Z}_{r , c B}^{( B )}\end{matrix} ]$$

The matrix on the right side is called the “LED-specific backlight-contribution matrix,” which is also represented by the expression

$$L S {F}_{r , c}^{( B )} .$$

This matrix indicates the contribution to pixel r, c from backlight B when that backlight is fully powered on (e.g., when b^{(B)} is set to 1.0 in normalized values, meaning full power). In particular, each column from the matrix indicates a measurement, in the tristimulus color space, with the backlight B fully powered and with either the red liquid crystal color element 306 (R), the green liquid crystal color element 306 (G), or the blue liquid crystal color element 306 (B) fully open, with the other liquid crystal color elements 306 fully closed, and no other backlight powered on (e.g., all other backlights powered off). For example, the following matrix:

$$[ \begin{matrix}{X}_{r , c R}^{( B )} \\ {Y}_{r , c R}^{( B )} \\ {Z}_{r , c R}^{( B )}\end{matrix} ]$$

represents the XYZ tristimulus color values measured at pixel r, c with backlight number B fully powered, with all other backlights fully off, and with the red liquid crystal color element 306 at pixel r,c fully open (and the blue and green ones fully closed). Similarly,

$$[ \begin{matrix}{X}_{r , c G}^{( B )} \\ {Y}_{r , c G}^{( B )} \\ {Z}_{r , c G}^{( B )}\end{matrix} ] and [ \begin{matrix}{X}_{r , c B}^{( B )} \\ {Y}_{r , c B}^{( B )} \\ {Z}_{r , c B}^{( B )}\end{matrix} ]$$

represent the XYZ tristimulus color values measured at pixel r,c with backlight number B fully powered and, for the matrix with subscript G, the green liquid crystal color element 306 fully open (and red and blue ones fully closed), and for the matrix with subscript G, the blue liquid crystal color element 306 fully open (and red and green ones fully closed). These three expressions are referred to as the “red measured backlight contribution matrix,” the “green measured backlight contribution matrix,” and the “blue measured backlight contribution matrix,” respectively. As can be seen, the full LED-specific backlight-contribution matrix represents the total light that would be emitted at pixel r, c with backlight B fully powered and all liquid crystal color elements 306 fully open. The mini-LED power level b^{(B)} scales this contribution, multiplying the matrix by a scalar value (which thus scales each element of that matrix by that value). The total contribution from all backlights to a particular pixel r, c is thus equal to the total backlight contribution expression, which combines the contribution from each backlight to the pixel by summing those contributions. Finally, the actual output at pixel r, c is equal to the activation matrix multiplied with the total backlight contribution expression. As described above, the activation matrix expression provides the parameters (e.g., activation levels) for the liquid crystal color elements 306 for a pixel at r, c, given the above total backlight contribution matrix and the desired color expressed in the XYZ tristimulus color space. In particular, as described above, once the total backlight contribution matrix is determined, its inverse is taken. The inverse of a matrix M is written M⁻¹ and equals the matrix for which M×M⁻¹=I, where I is the identity matrix (e.g., the matrix of the same size as M, where the elements from the top-left to the bottom-right equal 1 and each other element equals 0). As can be seen, in order to determine how to set the liquid crystal color elements 306 of a pixel at pixel r, c to produce a desired color, the inverse of a total backlight contribution matrix, derived from measured values and backlight settings, is multiplied with the desired color.

Above, it is stated that the red measured backlight contribution matrix, the green measured backlight contribution matrix, and the blue measured backlight contribution matrix are measured. In other words, in some examples, these values are taken from optical measurements of a physical display device. In an example, at manufacture time or design time, to obtain any such matrix for a particular pixel r, c, and a particular backlight B, all backlights except B of the device are fully closed, and backlight B is fully powered on. Further, all pixels other than r, c are fully closed (e.g., made completely non-transmissive), and one of the three liquid crystal color elements 306 at pixel r, c is made fully open with the other two fully closed. The liquid crystal color element 306 that is fully open is the one for which the measured backlight contribution matrix is being measured. In an example, for the red measured backlight contribution matrix, for backlight B and pixel r, c, the red liquid crystal color element 306 at pixel r, c is fully open, with the blue and green liquid crystal color elements 306 at pixel r, c fully closed and all other backlights and pixels fully closed. This process is repeated for each combination of pixel, backlight, and color component, resulting in a measured backlight contribution matrix for each combination of pixel and backlight. These matrices are then stored in a memory for use when the display device is in operation, in order to determine the activation matrix that indicates the liquid crystal color element settings 306 given an input image in the XYZ tristimulus color space and a backlight power for each backlight (collectively “backlight settings”). It should be noted that these backlight settings are determined through some mechanism not disclosed herein and are inputs to the techniques described herein. In other words, the techniques described herein determine the activation matrix, given a desired color for each pixel and the backlight settings.

Above, it is stated that an LED-specific backlight contribution matrix is determined for each combination of pixel and mini-LED 302. However, it is also possible to limit which mini-LEDs 302 to measure for any given pixel, such that very distant LEDs 302 are assumed to contribute no light to that pixel. In any case, for any given pixel r, c, the total backlight contribution expression would add the contributions for each LED for which such data exists, and would ignore the contribution for any LED for which no data exists.

In summary, to determine the activation matrix for any given pixel r, c and for a desired color for that pixel, stored values for measured backlight contribution matrices are multiplied with corresponding backlight power levels, and the resulting products are summed to obtain the total backlight contribution expression, which is a matrix. The inverse of this matrix is taken, and this inverse matrix is multiplied with the matrix representing the desired color in the XYZ color space to obtain the activation matrix for that pixel. This process is performed for each pixel in order to determine how to operate the display device 124 by setting the activation values for each pixel. Any or all of these operations can be performed by the display device 124 (e.g., by control electronics of the display device 124), by other circuitry (e.g., within the processor 102), and/or by software (such as a driver or firmware executing on a graphics processor or other device driver).

FIG. 7 is a flow diagram of a method 700 for controlling a display device, according to an example. Although described with respect to the system of FIGS. 1-6, those of skill in the art will understand that any system configured to perform the steps of the method 700 in any technically feasible order falls within the scope of the present disclosure. In various examples, the method 700 is performed by control logic, which is any technically feasible system configured to perform these steps. Examples of this control logic include software or firmware in the display device 124, in the processor 102, and/or hardware (e.g., circuitry) within the display device 124, the processor 102, or another entity. The term “control logic” refers to any feasible implementation of software or hardware (e.g., circuitry such as digital circuitry) that is capable of and/or configured to perform the operations described herein.

At step 702 control logic determines a desired color based on an input image. The input image is provided by an entity such as a driver executing on the processor 102. In some examples, the input image includes the contents of a frame buffer, which stores the output of rendering of a frame of graphical data by the processor 102 or other device. The input image is a two dimensional array that specifies a color for each of a set of pixels. In some examples, the input image is in a red-green-blue (“RGB”) color space. Pictures are typically stored in an RGB color space. Graphics are also typically rendered to an RGB color space. The XYZ color space described herein is used as an intermediary. Storing values in an RGB color space is more efficient storage-wise. For most RGB color spaces, every possible combination of values corresponds to a real-world physically possible color. However, in XYZ, many of the combinations of values correspond to “imaginary” colors that cannot physically exist. In some examples, the input image is in a non-linear gamma RGB color space (“R′G′B′”). Thus in some examples, step 702 involves converting the input image from gamma-encoded RGB values to linear RGB values. Gamma-encoded RGB values differ from non-gamma-encoded RGB values in the following manner. For linear (non-gamma-encoded) RGB values, the same numerical difference in luminance results in a differing perceived increase or decrease depending on the absolute value of the luminance. For example, the difference between 5 and 6 nits—1 nit—is quite different than the difference between 1005 and 1006 nits—also 1 nit, in terms of perceived light intensity. The former is perceived by the human eye as a much larger change than the latter. Gamma-encoded RGB values are encoded such that a particular numerical difference has the same perceived luminance difference regardless of the absolute value. Further, in some examples, step 702 involves converting from the linear RGB color space to a tristimulus XYZ color space, in which colors are represented in a different format. Conversion from linear RGB to tristimulus XYZ can be performed by multiplying the linear RGB color by a known conversion matrix which simply has a set of constant values as its elements.

At step 704, the control logic determines a backlight-based modification based on backlight levels and stored per-backlight, per-pixel data. The backlight levels indicate a brightness level for each of B backlights of the display device 124. The stored per-backlight, per-pixel data includes, for each pixel, a light spread function for each of a plurality of backlights 302. Each light spread function indicates the contribution in the tristimulus XYZ color space of a particular backlight to a particular pixel. These light spread functions are stored as data that is used to perform the steps of the method 700. In some examples, for any particular pixel, the control logic multiples each the light spread function for each backlight by the level (e.g., power level, intensity level) of that backlight to obtain a scaled backlight contribution, and sums the scaled backlight contribution for each such backlight together to obtain the backlight contribution for all backlights to the pixel (this is the “total backlight contribution”). In examples, this is expressed as a matrix (e.g., matrix “M” above).

At step 706, the control logic determines activation values for the liquid crystal elements 306 of the pixel. The control logic determines the inverse of this matrix and multiplies this value by the desired color for the pixel, determined in step 702. The result is a matrix that describes the activation values for the red, green, and blue liquid crystal elements 306 of the pixel. These activation values indicate the degree to which the red, green, and blue liquid crystal elements 306 should be opened, thus passing light from the backlight by a specified degree.

Steps 702, 704, and 706 produce activation values for one pixel, but this can be performed for each pixel of the display device 124, with each determining different values, including a different light spread function, based on the stored per-backlight, per-pixel data. In some examples, the control logic sets the pixel to the desired color by activating the liquid crystal elements 306 according to the activation values.

It should be understood that many variations are possible based on the disclosure herein. Although features and elements are described above in particular combinations, each feature or element can be used alone without the other features and elements or in various combinations with or without other features and elements.

Each of the units illustrated in the figures represent hardware circuitry configured to perform the operations described herein, software configured to perform the operations described herein, or a combination of software and hardware configured to perform the steps described herein. For example, the processor 102, memory 104, any of the auxiliary devices 106, the storage 108, the display controller 122, the display 124, or the image source 202 may be implemented as “hardware,” “software” or any technically feasible combination thereof; where “hardware” includes, without limitation, a general purpose computer, a processor, a processor core, a programmable logic device, a field programmable gate array, a digital circuit, an analog circuit, a fixed-function circuit; and where “software,” includes, without limitation, a program, an app, firmware, an application, a device driver, or any other set of executable instructions, stored in a non-transitory computer readable medium or in another medium, executable by a general purpose computer, a processor, or a processor core, or as any technically feasible combination of hardware or software. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. A method for controlling a display device, the method comprising:
receiving a desired color for a pixel based on an input image; and
applying activation values to the pixel to cause the pixel to output the desired color, wherein:
the activation values are based on a backlight-based modification and the desired color;
the backlight-based modification is based on backlight levels for a plurality of backlights and stored per-backlight, per-pixel data, and
the stored per-backlight, per-pixel data comprises a measured contribution for the pixel obtained with a respective backlight illuminated and other backlights of the plurality of backlights not illuminated.

2. The method of claim 1, further comprising determining the desired color.

3. The method of claim 2, wherein determining the desired color comprises converting a color value for the pixel from the input image to a tristimulus color space.

4. The method of claim 3, further comprising performing a degamma for the pixel from the input image to generate a color in linear light.

5. The method of claim 1, further comprising determining the backlight-based modification for the pixel by scaling a stored light spread function for a backlight of the plurality of backlights based on output levels for the backlights to obtain a plurality of scaled per-backlight contributions.

6. The method of claim 5, further comprising summing the plurality of scaled per-backlight contributions to obtain a backlight contribution matrix.

7. The method of claim 6, further comprising determining the activation value by multiplying an inverse of the backlight contribution matrix with the desired color.

8. The method of claim 5, wherein each stored light spread function indicates a contribution for a corresponding backlight to the pixel.

9. The method of claim 8, wherein each stored light spread function includes a portion for an X, Y, and Z component of a tristimulus color space for each of R, G, and B components of the pixel.

10. A system comprising:
a plurality of backlights;
a pixel; and
control circuitry configured to:
receive a desired color for the pixel based on an input image; and
apply activation values to the pixel to cause the pixel to output the desired color, wherein:
the activation values are based on a backlight-based modification and the desired color;
the backlight-based modification is based on backlight levels for the plurality of backlights and stored per-backlight, per-pixel data, and
the stored per-backlight, per-pixel data comprises a measured contribution for the pixel obtained with a respective backlight illuminated and other backlights of the plurality of backlights not illuminated.

11. The system of claim 10, wherein the control circuitry is further configured to determine the desired color.

12. The system of claim 11, wherein determining the desired color comprises converting a color value for the pixel from the input image to a tristimulus color space.

13. The system of claim 12, wherein the control circuitry is further configured to perform a degamma for the pixel from the input image to generate a color in linear light.

14. The system of claim 10, wherein the control circuitry is further configured to determine the backlight-based modification for the pixel by scaling a stored light spread function for a backlight of the plurality of backlights based on output levels for the backlights to obtain a plurality of scaled per-backlight contributions.

15. The system of claim 14, wherein the control circuitry is further configured to sum the plurality of scaled per-backlight contributions to obtain a backlight contribution matrix.

16. The system of claim 15, wherein the control circuitry is further configured to determine the activation value by multiplying an inverse of the backlight contribution matrix with the desired color.

17. The system of claim 14, wherein each stored light spread function indicates a contribution for a corresponding backlight to the pixel.

18. The system of claim 17, wherein each stored light spread function includes a portion for an X, Y, and Z component of a tristimulus color space for each of R, G, and B components of the pixel.

19. A non-transitory computer-readable medium storing instructions that, when executed by a processor, cause the processor to perform operations comprising:
receiving a desired color for a pixel based on an input image; and
applying activation values to the pixel to cause the pixel to output the desired color, wherein:
the activation values are based on a backlight-based modification and the desired color;
the activation values are based on a backlight-based modification and the desired color;
the backlight-based modification is based on backlight levels for a plurality of backlights and stored per-backlight, per-pixel data, and
the stored per-backlight, per-pixel data comprises a measured contribution for the pixel obtained with a respective backlight illuminated and other backlights of the plurality of backlights not illuminated.

20. The non-transitory computer-readable medium of claim 19, wherein the operations further comprise determining the desired color.
